(19) United States
(12) Patent Application Publication
(10) Pub. No.: US 2026/0303674 A1
(43) Pub. Date: Oct. 1, 2026

(54) SYSTEM, COMPUTER-IMPLEMENTED METHOD, AND NON-TRANSITORY COMPUTER-READABLE STORAGE MEDIA

(71) Applicant: Nintendo Co., Ltd., Kyoto-shi (JP)

(72) Inventors: Ryota OIWA, Kyoto-shi (JP); Masayoshi KOBAYASHI, Kyoto-shi (JP); Shuta IWAMOTO, Kyoto-shi (JP); Toshiaki OOMORI, Kyoto-shi (JP); Akifumi FUJITA, Kyoto-shi (JP); Norihiro KOZAWA, Kyoto-shi (JP); Ryo TAKAHASHI, Kyoto-shi (JP); Masaki JONO, Kyoto-shi (JP)

(21) Appl. No.: 19/571,293

(22) Filed: Mar. 18, 2026

(30) Foreign Application Priority Data
Mar. 26, 2025 (JP) 2025-050948

(51) Int. Cl. H04L 65/1089; H04L 65/403

(52) U.S. Cl. CPC H04L 65/1089; H04L 65/403

(57) ABSTRACT

A system for managing camera image distribution. The system acquires a captured image of a camera and executes a chat application configured to distribute the image to other terminals. Distribution of the captured image is restricted based on a first application, such as a game application or a video content viewing application, being executed simultaneously with the chat application. The restriction may be triggered by the display of the first application's image, a request from the first application, or the selection of specific camera image display modes. Users may be notified of the restriction, and distribution can be resumed based on user operations after the restriction is released.

This nonprovisional application claims priority on Japanese Patent Application No. 2025-050948 filed with the Japan Patent Office on Mar. 26, 2025, the entire contents of which are hereby incorporated by reference.

### FIELD

The present disclosure relates to a system, a method, and a program.

### BACKGROUND AND SUMMARY

A game device capable of a chat using a camera image is publicly known.

In a system capable of distribution of a camera image and execution of an application such as a game application etc., there is room for improvement regarding control of the distribution of the camera image.

Configuration 1: A system comprising one or more processors and one or more non-transitory computer-readable storage media having stored therein instructions that cause the one or more processors to perform operations comprising: acquiring a captured image of a camera; executing a chat application configured to distribute the captured image of the camera; and restricting distribution of the captured image of the camera by the chat application based on a first application being a game application or a video content viewing application executed simultaneously with the chat application.

Configuration 2: In Configuration 1, the chat application is configured to distribute an image of an application executed simultaneously, and the operations comprise restricting the distribution of the image of the first application by the chat application based on the first application executed simultaneously with the chat application.

Configuration 3: In Configuration 1, when the restriction of the distribution of the captured image of the camera based on the first application is released, the distribution of the captured image of the camera by the chat application is started based on a user operation.

Configuration 4: In Configuration 1, when the image of the first application being executed is displayed on a display, the distribution of the captured image of the camera by the chat application is restricted.

Configuration 5: In Configuration 1, when the distribution of the captured image of the camera by the chat application is restricted based on the first application being executed, a user of a terminal on which the chat application and the first application are executed is notified that the distribution of the captured image of the camera by the chat application is restricted.

Configuration 6: In Configuration 1, when the distribution of the captured image of the camera by the chat application in the terminal on which the chat application and the first application are executed is restricted, a user of another terminal chatting by the chat application with the terminal is notified that the distribution of the captured image of the camera by the chat application in the terminal is restricted.

Configuration 7: In Configuration 1, the captured image of the camera distributed by the chat application is an image based on a camera image display mode selected from a plurality of camera image display modes including a camera image display mode including a background of a person and a camera image display mode not including the background of the person, and when the selected camera image display mode is the camera image display mode including the background of the person, the distribution of the captured image of the camera by the chat application is restricted based on the first application.

Configuration 8: In Configuration 1, the terminal provided with the display on which the chat application and the first application are executed does not include a camera, and the camera is connected to the terminal.

Configuration 9: In Configuration 1, the chat application restricts the distribution of the captured image of the camera based on a request from the first application.

Configuration 10: In Configuration 9, the chat application is configured to acquire the captured image of the camera and distribute the acquired captured image, and the operations comprise restricting acquisition of the captured image of the camera by the chat application based on the request of the first application.

Configuration 11: In Configuration 1, the system includes a server, and the server is configured to: receive the captured image of the camera from the terminal on which the chat application is executed; distribute the received captured image of the camera to another terminal on which the chat application is executed; acquire information indicating that the first application is being executed in the terminal; and restrict the distribution of the received captured image of the camera to the other terminal based on the information.

Configuration 12: A computer-implemented method comprises: acquiring a captured image of a camera; executing a chat application configured to distribute the captured image of the camera; and restricting distribution of the captured image of the camera by the chat application based on a first application being a game application or a video content viewing application executed simultaneously with the chat application.

Configuration 13: In Configuration 12, the chat application is configured to distribute an image of an application executed simultaneously, and the method comprises restricting the distribution of the image of the first application by the chat application based on the first application executed simultaneously with the chat application.

Configuration 14: In Configuration 12, when the image of the first application being executed is displayed on a display, the distribution of the captured image of the camera by the chat application is restricted.

Configuration 15: In Configuration 12, the captured image of the camera distributed by the chat application is an image based on a camera image display mode selected from a plurality of camera image display modes including a camera image display mode including a background of a person and a camera image display mode not including the background of the person, and when the selected camera image display mode is the camera image display mode including the background of the person, the distribution of the captured image of the camera by the chat application is restricted based on the first application.

Configuration 16: In Configuration 12, the chat application is configured to acquire the captured image of the camera and distribute the acquired captured image, and the method comprises restricting acquisition of the captured image of the camera by the chat application based on the request of the first application.

Configuration 17: One or more non-transitory computer-readable storage media have stored therein instructions that cause one or more processors to perform chat operations comprising: acquiring a captured image of a camera; executing a chat with another terminal; distributing the captured image of the camera to the another terminal during the chat; and restricting distribution of the captured image of the camera based on a first application being a game application or a video content viewing application, the first application being executed on the terminal.

Configuration 18: In Configuration 17, when the image of the first application being executed is displayed on a display, the distribution of the captured image of the camera by the chat application is restricted.

Configuration 19: In Configuration 17, the captured image of the camera distributed by the chat application is an image based on a camera image display mode selected from a plurality of camera image display modes including a camera image display mode including a background of a person and a camera image display mode not including the background of the person, and when the selected camera image display mode is the camera image display mode including the background of the person, the distribution of the captured image of the camera by the chat application is restricted based on the first application.

Configuration 20: In Configuration 17, the chat application is configured to acquire the captured image of the camera and distribute the acquired captured image, and the chat operations comprise restricting acquisition of the captured image of the camera by the chat application based on the request of the first application.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic diagram showing a configuration example of a system according to the present embodiment.

FIGS. 2A and 2B are diagrams for explaining an example of a chat screen generated in a game device according to the present embodiment.

FIG. 3 is a schematic diagram showing a hardware configuration example of a game device according to the present embodiment.

FIG. 4 is a schematic diagram showing a software configuration example of a game device according to the present embodiment.

FIGS. 5A, 5B, and 5C are diagrams for explaining an example of a camera image display mode in a game device according to the present embodiment.

FIGS. 6A and 6B are diagrams for explaining an example of a chat screen generated in a game device according to the present embodiment.

FIGS. 7A and 7B are diagrams for explaining an example of a chat screen generated in a game device according to the present embodiment.

FIG. 8 is a flowchart showing an example of a processing procedure of processing executed in a game device according to the present embodiment.

FIG. 9 is a flowchart showing an example of a processing procedure of processing executed in a game device according to the present embodiment.

### DETAILED DESCRIPTION OF NON-LIMITING EXAMPLE EMBODIMENTS

The present embodiment will be described in detail with reference to the drawings. Note that the same or corresponding parts in the drawings are denoted by the same reference numerals and description of the same or corresponding parts will not be repeated.

Even in a case where data is described using the same term, contents of the data do not necessarily match completely. At least, in a case where both certain data and another data transmit specific information, the certain data and the another data may be regarded as the same data. Also, names given to the data are for convenience, and do not limit a range or technical meaning indicated by the data.

A program that causes a computer to execute processing may be a single program, or may be a program group including a plurality of programs. In the present disclosure, "a program" does not necessarily mean a single program and may include a program group. Also, "a program" does not need to be entirely stored in one device. "A program" may mean, for example, the whole of a plurality of programs respectively stored in a plurality of devices included in a computer.

### A. Configuration Example of System

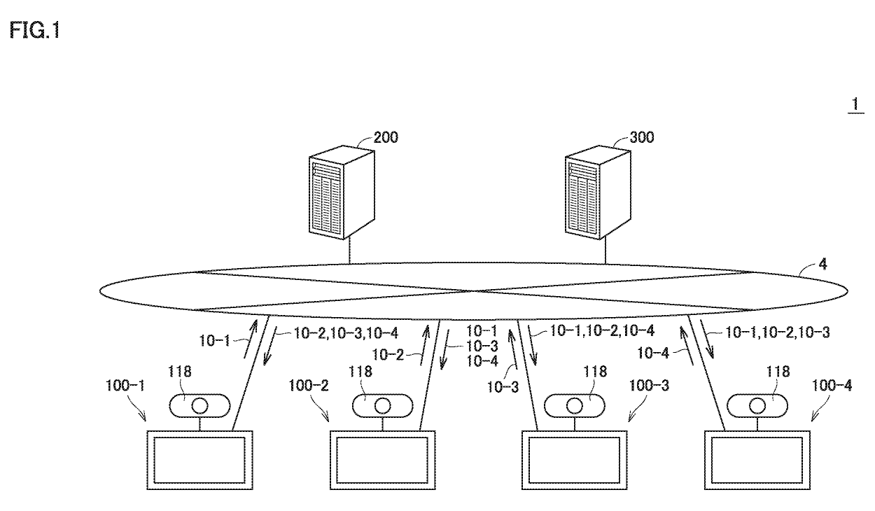

FIG. 1 is a schematic diagram showing a configuration example of a system 1 according to the present embodiment. The system 1 includes one or more game devices 100. At least a part of the game devices 100 can use a camera 118. FIG. 1 shows a configuration example of the system 1 including four game devices 100 connected to a network 4. In the following description, in a case where it is necessary to identify each of the plurality of game devices 100, the game devices 100 are distinguished by adding branch numbers (for example, game devices 100-1, 100-2, 100-3, 100-4 shown in FIG. 1).

In the system 1 according to the present embodiment, a user using a game device 100 has an account of the user, and the account of the user is associated with each game device 100. A user having an account can cause the associated account to participate in one or more chat groups (hereinafter, also abbreviated as "group") by performing a specified input to the game device 100. A game device 100 corresponding to an account belonging to any group transmits data used for communication between users (hereinafter, also referred to as "communication data 10") to another game device 100 corresponding to another account belonging to the group. Thereby, communication between users is realized within the group. Note that "chat" does not necessarily mean bidirectional communication. For example, a case where a certain game device 100 unilaterally transmits a camera image etc. to another game device 100 may also be called "chat".

The communication data 10 may include, for example, sound data acquired by the game device 100, image data acquired by the game device 100, text data acquired by the game device 100, information regarding an application executed in the game device 100, etc. Note that it is not necessary that all data are included in one communication data 10, and one data may be divided into a plurality of pieces of communication data 10. One piece of communication data 10 may include a plurality of pieces of data.

In the present specification, "image data" includes moving image data and one or more pieces of still image data. For example, the image data may be captured using the camera 118 etc., or may be output from an application executed in the game device 100. A method of generating the image data is not limited.

The system 1 may further include a management server 200 and a relay server 300. The management server 200 is in charge of processing to newly configure a group, processing for one or more accounts to participate in a group, etc. The relay server 300 relays communication data 10 transmitted and received by one or more game devices 100. The management server 200 and the relay server 300 may be implemented in a single physical server.

A method in which a certain game device 100 transmits communication data 10 to one or more other game devices 100 may be a method of directly transmitting the communication data 10 to one or more other game devices 100 (for example, a P2P method etc.) in addition to or instead of a method via one or more relay entities (for example, the relay server 300).

### B. Example of Chat Screen

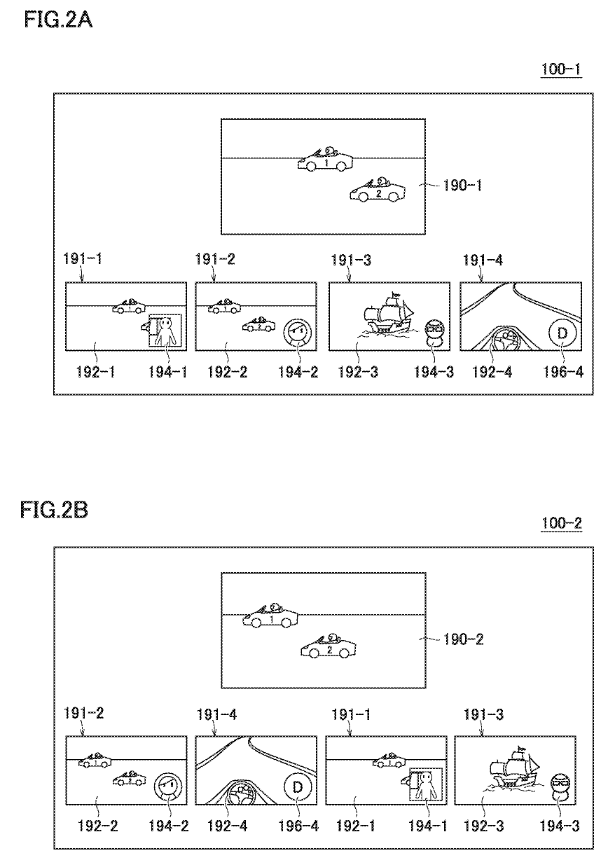

FIGS. 2A and 2B are diagrams for explaining an example of a chat screen generated in a game device 100 according to the present embodiment.

As an example, as shown in FIG. 1, four accounts belong to the same group, and the game devices 100-1 to 100-4 correspond to the four accounts, respectively. In FIGS. 2A and 2B, as an example, it is assumed that the game devices 100-1 to 100-3 distribute camera images and the game device 100-4 does not distribute a camera image.

FIG. 2A shows an example of a chat screen displayed on a display 120 of the game device 100-1, and FIG. 2B shows an example of a chat screen displayed on a display 120 of the game device 100-2. The chat screen shown in FIGS. 2A and 2B are examples, and a screen configuration of a chat screen created using the communication data 10 is not limited.

As shown in FIG. 2A, the example of the chat screen of the game device 100-1 includes a game image 190-1 of a game application being executed in the game device 100-1. The example of the chat screen of the game device 100-1 includes distributed images 191-1 to 191-4 respectively distributed by the game devices 100-1 to 100-4. The distributed images 191-1 to 191-4 may include at least any of a distributed game image, a camera image, and an icon image. For example, the distributed image 191-1 includes a distributed game image 192-1 and a camera image 194-1 distributed by the game device 100-1. As an example, the camera image is displayed superimposed on the distributed game image. Since the game device 100-4 does not distribute a camera image, an icon image 196-4 indicating an account corresponding to the game device 100-4 is superimposed on the distributed image 191-4. The icon image 196-4 may also be an example of a distributed image. The icon image itself is not distributed, and for example, an identifier of the icon image may be distributed.

As shown in FIG. 2B, the example of the chat screen of the game device 100-2 includes a game image 190-4 of a game application being executed in the game device 100-2. Also, similarly to the example of the chat screen of the game device 100-1, the example of the chat screen of the game device 100-2 includes the distributed images 191-1 to 191-4 respectively distributed by the game devices 100-1 to 100-4. However, a display order of the distributed images may be different from the example of the chat screen of the game device 100-1 shown in FIG. 2A. In this example, the game device 100-2 distributes the distributed image 191-2 including a distributed game image 192-2 to another game device.

Each of camera images 194-1 to 194-3 is an image corresponding to a camera image display mode (hereinafter, also abbreviated as "display mode") set in a game device 100 of a distribution source. Details of the display mode will be described later.

### C. Hardware Configuration Example of Game Device 100

Next, a game device 100 which is an example of an information processing apparatus will be described. The information processing apparatus is not limited to the game device 100, and may be, for example, a personal computer, a television, a tablet terminal, a smartphone, a wearable terminal, a server, etc.

Also, the game devices 100 respectively corresponding to a plurality of accounts belonging to the same group do not need to have the same hardware configuration. For example, some game devices 100 are game consoles, and other game devices 100 may be personal computers, televisions, tablet terminals, smartphones, wearable terminals, servers, etc. capable of executing a game application. The game device 100 may be any computer capable of executing at least a game application.

Note that in the present specification, "computer" does not necessarily mean one device, and may include the whole in which a plurality of devices are connected by wire or wirelessly. Also, in a case where the information processing apparatus is configured by a plurality of devices, each of the plurality of devices may be an example of the information processing apparatus.

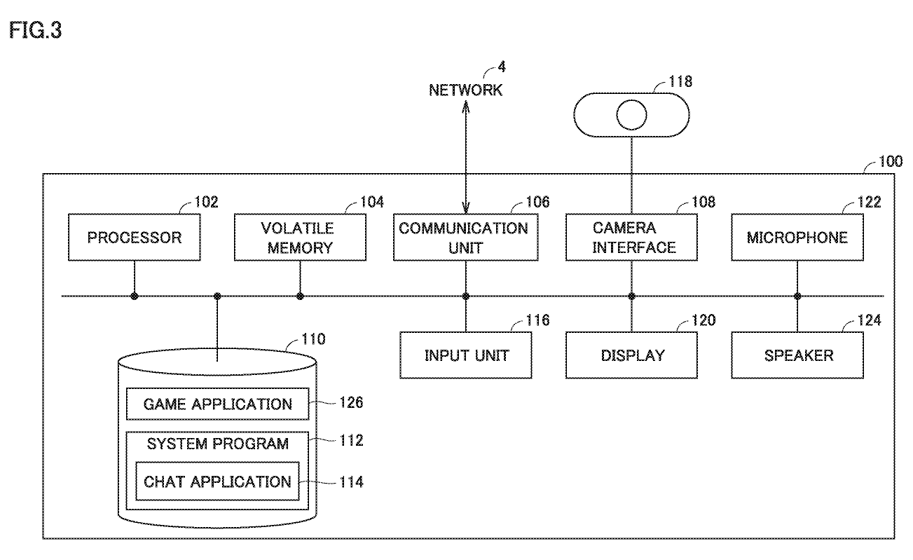

FIG. 3 is a schematic diagram showing a hardware configuration example of a game device 100 according to the present embodiment. Referring to FIG. 3, the game device 100 includes, for example, one or more processors 102, one or more volatile memories 104, a communication unit 106, a camera interface 108, one or more non-volatile memories 110, an input unit 116, a display 120, a microphone 122, and a speaker 124. Each component may be removable from a main body of the game device 100.

The processor 102 is a processing subject for executing processing in the game device 100. The processor 102 includes, for example, a CPU (Central Processing Unit) and a GPU (Graphics Processing Unit) etc. The processor 102 expands a program stored in the non-volatile memory 110 into the volatile memory 104 and executes the program.

The volatile memory 104 is a volatile storage medium accessible by the processor 102, and includes, for example, DRAM (Dynamic Random Access Memory) and SRAM (Static Random Access Memory) etc.

The non-volatile memory 110 is a non-volatile storage medium accessible by the processor 102, and includes, for example, a flash memory and a hard disk etc. The non-volatile memory 110 may include, for example, a storage medium detachable from the game device 100 such as a cartridge or an optical disk. The non-volatile memory 110 is also referred to as a storage.

The non-volatile memory 110 stores, for example, one or more programs such as a system program 112 and a game application 126.

The system program 112 includes computer-readable instructions for hardware control of the game device 100, providing a program execution environment, etc. The system program 112 may include one or more programs or program modules. For example, the system program 112 includes a chat application 114.

The chat application 114 executes processing regarding transmission and reception of communication data 10 between a plurality of game devices 100 corresponding to a plurality of accounts belonging to a group.

The game application 126 includes computer-readable instructions for executing a game. A plurality of game applications 126 may be installed in the game device 100. Also, the game application 126 may be read from a separate storage medium. Also, at least a part of game execution by the game application 126 may use another game device 100, or may use external resources such as a server. Also, the system program 112 may include at least a part of the game application 126.

In the present specification, "processor" may include at least a processing circuit that executes processing according to computer-readable instructions such as a CPU and a GPU, and a hard-wired circuit such as an ASIC (Application Specific Integrated Circuit) and an FPGA (Field Programmable Gate Array). In the present specification, "memory" may include at least the volatile memory 104 and the non-volatile memory 110, and may include other storage media and storage devices.

In the game device 100, an SoC (System on Chip) in which functions of a processor, a memory, etc. are integrated may be adopted. In this case, the processor and the memory exist in the same SoC (integrated circuit). Therefore, in the present specification, "processor" and "memory" may include at least both a configuration independent of each other and a configuration integrated with each other.

The communication unit 106 transmits and receives data to and from another game device 100, the management server 200, the relay server 300, etc. via the network 4. The communication unit 106 may perform data communication with another game device 100 etc. via the Internet as an example of the network 4. Also, as the network 4, a wireless network according to Bluetooth (registered trademark), ZigBee (registered trademark), wireless LAN (IEEE 802.11 standard), etc. may be used.

The camera interface 108 mediates data transmission to the camera 118 and data reception from the camera 118. The camera interface 108 may be connected to the camera 118 by wire, or may be connected to the camera 118 wirelessly.

The input unit 116 accepts a user operation. The input unit 116 includes, for example, a keyboard, a mouse, a game controller, a touch panel, etc. The input unit 116 may be an interface with a device (for example, a game controller) that accepts a user operation. In this way, the device that accepts the user operation may exist outside the game device 100.

The display 120 displays an image or a video generated by processing by the processor 102. The display 120 includes, for example, an LCD (Liquid Crystal Display), an organic EL display, etc. The display 120 may exist outside the game device 100. In this case, the game device 100 may include an interface circuit with the display 120.

The microphone 122 is arranged in a housing etc. of the game device 100, and collects sound to generate a sound signal. The speaker 124 is arranged in a housing etc. of the game device 100, and generates sound from a sound signal. At least one of the microphone 122 and the speaker 124 may exist outside the game device 100.

The camera 118 generates camera data (moving image data or still image data) in which a subject is imaged according to a command from the game device 100 or according to a specified condition. The camera 118 includes, for example, an imaging element such as a CCD (Charge-Coupled Device) image sensor or a CMOS (Complementary Metal Oxide Semiconductor) image sensor. A lens may be arranged in a preceding stage of the imaging element.

The camera 118 may be, for example, a camera for video calls. The camera 118 may be a dedicated camera connectable only to a specific device, or may be a general-purpose camera connectable to any device. A plurality of cameras 118 may be connectable to the game device 100. Furthermore, the game device 100 may use a camera of another information processing apparatus (for example, a smartphone). In this way, a configuration in which the game device 100 uses the camera 118 is not limited.

### D. Software Configuration Example of Game Device 100

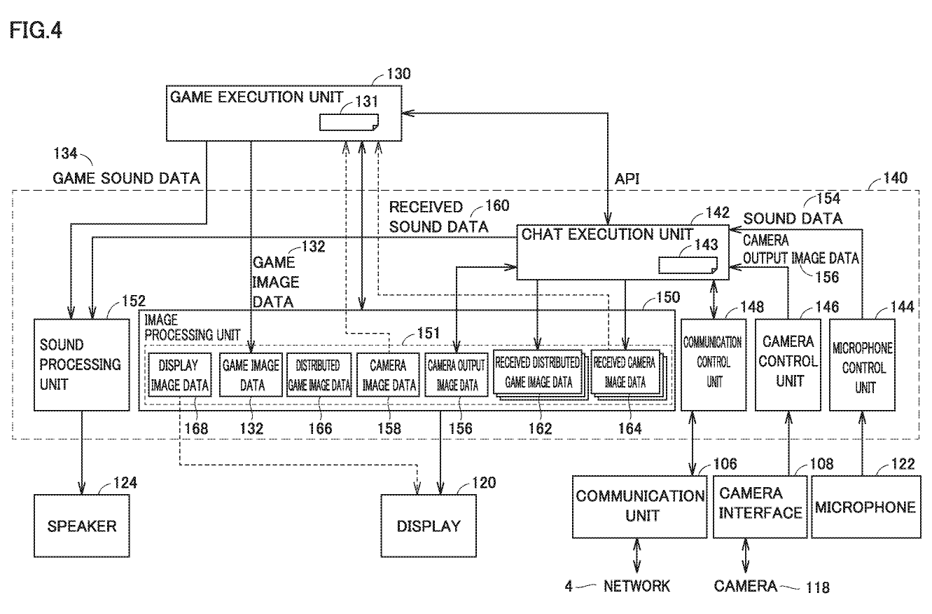

FIG. 4 is a schematic diagram showing a software configuration example of a game device 100 according to the present embodiment. Referring to FIG. 4, in the game device 100, the system program 112 including the chat application 114 and the game application 126 are simultaneously executable. Note that "simultaneously executable" means that a plurality of applications or programs are executed in parallel, and does not limit execution timing etc.

The game device 100 includes a system module 140 and a game execution unit 130 as an example of software components. The system module 140 may be realized by one or more processors 102 executing the system program 112. The system module 140 may also be called the system program 112 being executed. The game execution unit 130 may be realized by one or more processors 102 executing the game application 126. The game execution unit 130 may also be called the game application 126 being executed.

The game execution unit 130 progresses a game based on a user operation and outputs game image data 132 and game sound data 134. The game image data 132 may include, for example, a plurality of types of image data having different image quality, resolution, frame rate, etc. The game execution unit 130 may include specification information 131 specifying one or more display modes. The one or the plurality of display modes specified by the specification information 131 may be based on one or more display modes selectable on the chat screen shown in FIGS. 2A and 2B, or may be independent of each other.

The system module 140 provides basic functions necessary in the game device 100. The system module 140 includes, for example, a chat execution unit 142. The chat execution unit 142 may also be called the chat application 114 being executed. The chat execution unit 142 may include display mode information 143 indicating a current display mode of camera image data 158. Camera image data 158 corresponding to the display mode indicated by the display mode information 143 is generated.

The system program 112 may not include at least a part of the chat application 114. Similarly to the game application 126, at least a part of the chat application 114 may be an application separate from the system program 112. In the following description, the chat execution unit 142 may execute a part or all the processing executed by the system module 140. Therefore, in a context of processing executed by the system module 140, the system module 140 can be read as the chat execution unit 142, or the system module 140 can be read as the system module 140 and the chat execution unit 142.

The system module 140 includes, for example, a microphone control unit 144, a camera control unit 146, a communication control unit 148, an image processing unit 150, and a sound processing unit 152.

The microphone control unit 144 generates sound data 154 based on sound collected by the microphone 122 etc.

The camera control unit 146 generates camera output image data 156 based on an image captured by the camera 118 etc. The camera control unit 146 may be able to control start of imaging and stop of imaging etc. of the camera 118, and may be able to control imaging conditions (frame rate, white balance, etc.) of the camera 118.

The communication control unit 148 gives a command to the communication unit 106 to control data communication with another game device 100 etc.

The image processing unit 150 can use a storage area 151 for storing image data. The storage area 151 may use, for example, a part of an area of one or more volatile memories 104 or one or more non-volatile memories 110. The image processing unit 150 may be capable of image processing for one or more pieces of image data.

The storage area 151 may include, for example, an area for storing game image data 132, camera output image data 156, camera image data 158, one or more pieces of received distributed game image data 162, one or more pieces of received camera image data 164, distributed game image data 166, and display image data 168.

The camera image data 158 is generated from the camera output image data 156 according to the display mode. Note that instead of generating the camera image data 158 from the camera output image data 156, the camera 118 or the camera control unit 146 may generate the camera image data 158 according to the display mode.

The chat execution unit 142 executes processing for communication between users within a group. For example, the chat execution unit 142 may execute processing for participating in a specified group or leaving a group based on a user operation.

As processing for performing distribution, the chat execution unit 142 may generate and transmit communication data 10 based on at least a part of the sound data 154, the distributed game image data 166, and the camera image data 158. The distributed game image data 166 includes an image to be distributed to another game device 100. Note that "distribution" may mean, for example, that a certain game device 100 directly or indirectly transmits some data to one or more other game devices 100. "Distribution" and "transmission" may be interchangeable.

As processing for receiving distribution, the chat execution unit 142 may store received distributed game image data 162 and received camera image data 164 etc. included in one or more pieces of communication data 10 from one or more other game devices 100 in the storage area 151. As processing for receiving distribution, the chat execution unit 142 may output received sound data 160 included in one or more pieces of communication data 10 from one or more other game devices 100 to the sound processing unit 152. The sound processing unit 152 may generate a sound signal based on the sound data and output the generated sound signal to the speaker 124.

The image processing unit 150 may generate the display image data 168 using at least a part of the game image data 132, the camera image data 158, the one or the plurality of pieces of received distributed game image data 162, and the one or the plurality of pieces of received camera image data 164 according to a command from the chat execution unit 142. The display image data 168 is used to display an image or a video on the display 120 of the device itself.

### E. Camera Image Display Mode

In the game device 100 according to the present embodiment, a plurality of display modes may be prepared in the chat application 114 being executed. A user can set or change the display mode, for example, on a setting screen etc. of the chat application 114 being executed. The plurality of display modes may be modes in which display degrees around a face of a person included in an imaging range of the camera 118 are different from each other. The around the face may include a portion below the face (for example, a torso etc.). The display degree may include, for example, presence or absence of display, a blurring degree, etc.

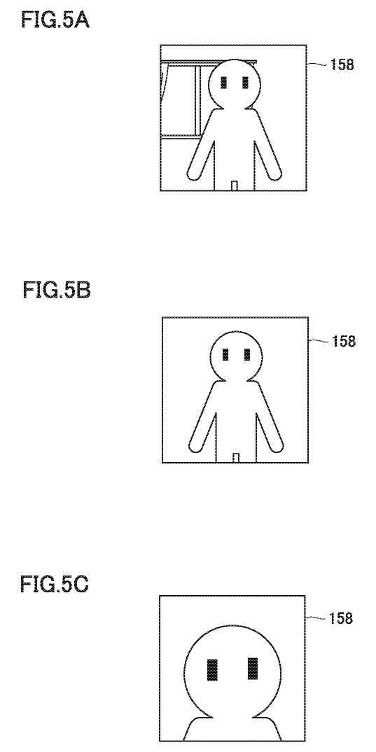

FIGS. 5A, 5B and 5C are diagrams for explaining an example of a camera image display mode in a game device 100 according to the present embodiment. FIGS. 5A, 5B and 5C illustrate three display modes as an example.

FIG. 5A shows an image example of the camera image data 158 when a full-view mode is selected as an example of the display mode. The image example shown in FIG. 5A is substantially the same as an image captured by the camera 118 (for example, camera output image data 156). It can also be said that a panoramic view of the image captured by the camera 118 is used as it is. In the full-view mode, all around the face of the person in the image captured by the camera 118 is displayed.

FIG. 5B shows an image example of the camera image data 158 when a clipping mode is selected as an example of the display mode. In the image example shown in FIG. 5B, only a person included in the imaging range of the camera 118 is clipped. In the clipping mode, a background around the person in the image captured by the camera 118 may be set to a specified color (for example, white) or a transparent color. It can also be said that in the clipping mode, the background around the person is not displayed. The image in the clipping mode may include the face of the person and at least a part of an upper body (for example, a range above a navel). In the image example shown in FIG. 5B, one person is clipped, but in a case where a plurality of persons are included in the imaging range of the camera 118, the plurality of persons may be clipped.

FIG. 5C shows an image example of the camera image data 158 when a face mode is selected as an example of the display mode. In the image example shown in FIG. 5C, a periphery of the face of the person included in the imaging range of the camera 118 is extracted. In the face mode, the periphery of the face of the person in the image captured by the camera 118 may be extracted. The image captured by the camera 118 may be enlarged as necessary. It can also be said that in the face mode, portions other than the face of the person are not displayed. The image in the face mode can also be said to include only the face.

In the face mode, the background around the face of the person may be displayed as it is, or may be blurred and displayed. Alternatively, the background around the face of the person may be set to a specified color (for example, white) or a transparent color. At this time, clipping processing may be executed along a contour of the face of the person.

Note that in the chat screen shown in FIGS. 2A and 2B described above, the user of the game device 100-1 selects the full-view mode, the user of the game device 100-2 selects the face mode, and the user of the game device 100-3 selects the clipping mode.

Although three display modes are illustrated as an example, the number of display modes is not limited, and display modes to be adopted are not limited. For example, the display mode may include a mode in which a background in a panoramic range is blurred and displayed. As a modification, in each mode described above, instead of clipping a rectangular area, a circular or elliptical area may be clipped. Also, the image data may include a frame of the clipped area.

The system module 140 may select a display mode based on a user operation. Generation of the camera output image data 156 corresponding to the display mode may be executed by at least a part of the camera control unit 146, the chat execution unit 142, and the image processing unit 150 (see FIG. 4), or may be executed by other configurations.

[F. Distribution Restriction] In a case where the system program 112 including the chat application 114 and the game application 126 are simultaneously executed, the system program 112 may restrict distribution of a game image based on the game application 126 being executed. As an example, a developer of a game may want to avoid a scene with high confidentiality of the game being watched by a person who has not played the game, or avoid the whole game or a specific scene of the game being watched by a person who is not an owner of the game. Therefore, the present system 1 has a function of restricting distribution of a game image of a game application being executed.

A method for restricting distribution of a game image is not limited. As an example, the game execution unit 130 may request the system module 140 to stop distribution of the game image. Based on the request, for example, if the system module 140 is transmitting a distributed game image, the system module 140 may stop the transmission. Alternatively, the system module 140 may distribute a black screen or a screen including a message such as "This is a scene that cannot be distributed" instead of the distributed game image. Alternatively, the management server 200 and or the relay server 300 may stop distribution of the game image included in the communication data 10-1 to another game device 100. Stop of distribution by the server may be based on a request from the game device 100. Alternatively, the server stores a specific game application as a distribution restriction target application, and when the game device 100 is trying to distribute an image of the specific game application, the server may stop distribution of the game image by the game device 100. Also, a specific scene of a specific game application may be stored in the server as a distribution restriction target scene. For example, the communication data 10 may include an identifier for identifying a game application being executed by the game device 100 or a game application for which a game image is to be distributed, and the server may determine whether or not the game application is a distribution restriction target application based on the identifier. The restriction of distribution of the game image may be realized by restricting display of a received distributed game image in another game device 100 after distribution of the game image to the another game device 100 is performed.

Note that exchange (for example, request and response etc.) between the system module 140 and the game execution unit 130 may follow any command system. As an example, an API (Application Programming Interface) may be used. For example, the game execution unit 130 may request the system module 140 to acquire camera image data 158 according to a command system defined in advance as an API. The same applies hereinafter.

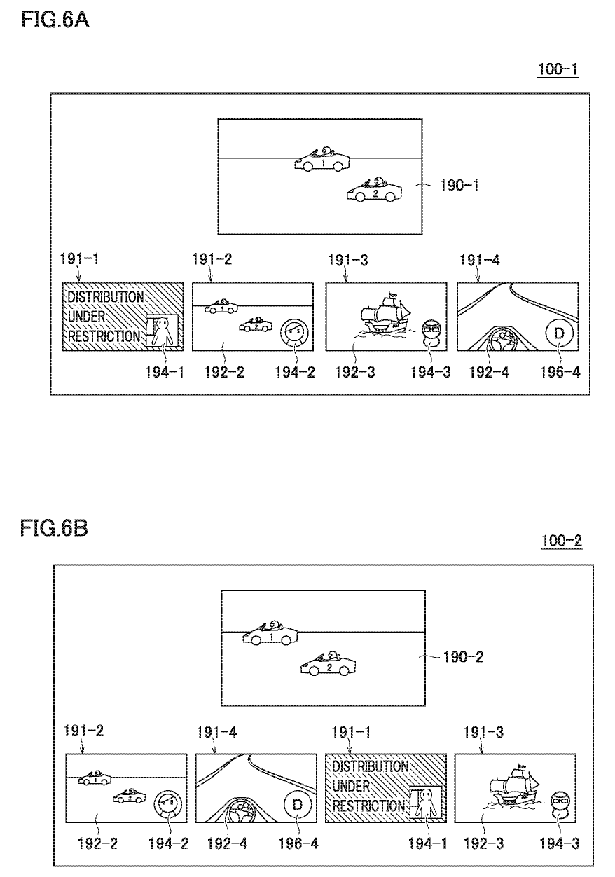

FIGS. 6A and 6B show an example of a chat screen when distribution of a game image of the game device 100 is restricted. FIG. 6A shows an example of a chat screen of the game device 100-1, and FIG. 6B shows an example of a chat screen of the game device 100-2. In either screen, the distributed game image 192-1 of the game device 100-1 is made invisible. In this example, a message "Distribution under restriction" is displayed as an announcement image. Thereby, any user can understand that the game application of the game device 100-1 is a game application for which distribution is restricted, or is in a scene where distribution is restricted. Note that as shown in FIG. 2A, on the chat screen of the game device 100-1, the game image 190-1 continues to be displayed. Therefore, the user of the game device 100-1 can continue playing the game for which distribution of the game image is restricted.

By the way, as shown in FIGS. 6A and 6B, the camera image 194-1 of the game device 100-1 continues to be distributed. As an example, in a case where a position or posture of the camera 118 and the display 120 are relatively changeable, there is a possibility that the camera 118 is directed toward the display 120. At this time, an image including the game image 190-1 may be distributed as the camera image 194-1. Therefore, in the present embodiment, the system 1 restricts distribution of a camera image based on a game application being executed.

A method for restricting distribution of a camera image is not limited, similarly to the method for restricting distribution of a game image. For example, the game execution unit 130 may request the system module 140 to stop distribution of the camera image. In response to the request, the system module 140 may stop acquiring camera output image data 156 from the camera interface 108 or from the camera control unit 146, or may stop transmitting after acquiring the camera output image data 156. Alternatively, distribution of the camera image may be restricted by the server. Alternatively, display of a received camera image may be restricted by a game device that has received the camera image.

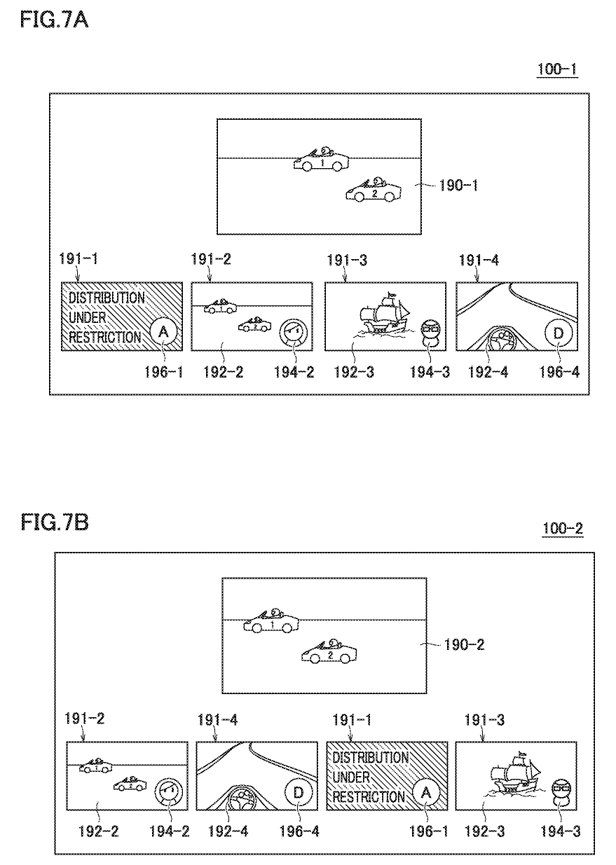

FIGS. 7A and 7B show an example of a chat screen when distribution of a camera image and a game image of the game device 100 is restricted. FIG. 7A shows an example of a chat screen of the game device 100-1, and FIG. 7B shows an example of a chat screen of the game device 100-2. In either screen, a message "Distribution under restriction" is displayed instead of the distributed game image 192-1 of the game device 100-1, and an icon image 196-1 indicating an account corresponding to the game device 100-1 is displayed instead of the camera image 194-1. Note that the icon image 196-1 may not be displayed. Also, an announcement image indicating that the camera image cannot be displayed due to the game application being executed may be displayed. The image may be, for example, an illustration or a message. As an example, a message "This is a scene where a camera cannot be used." may be displayed. The announcement image may be displayed on the game device 100-1, or may be displayed on other game devices 100-2 to 100-4.

Note that a user may be able to respectively turn ON or OFF (namely, mute) distribution of a camera image, distribution of a game image, and distribution of sound in a chat menu. As an example, while distribution of a camera image is restricted, a user interface for turning ON or muting the distribution of the camera, for example, a camera distribution button, is fixed to mute, and a changing operation by the user is made not to be accepted. The same applies to distribution of a game image.

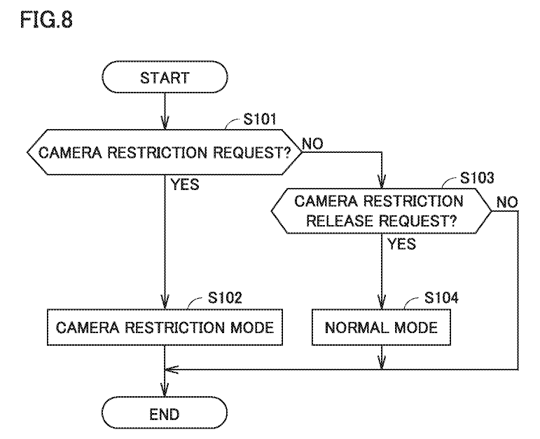

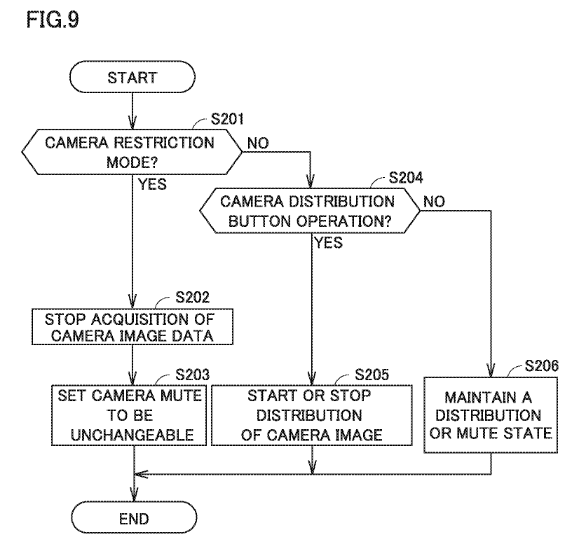

FIGS. 8 and 9 are flowcharts showing an example of a procedure of processing executed in the game device 100 according to the present embodiment. Each step may be realized by one or more processors 102 executing the system program 112.

Processing described in the present embodiment may include other processing, or may not include a part of processing. Also, an execution order of each processing is an example, and for example, a plurality of pieces of processing may be executed in parallel, or some pieces of processing may be executed in an order reverse to description. For convenience of description, processing is divided into units called steps, but these units of division are arbitrary, and a plurality of steps may be integrated into one, or one step may be divided into a plurality of steps. The same applies to description below. Processing in FIGS. 8 and 9 is repeatedly executed at specified intervals (for example, a processing frame interval executed every 1/60 second) as an example.

Referring to FIG. 8, when receiving a camera restriction request from, for example, the game execution unit 130 (step S101), the system module 140 sets a camera restriction mode (step S102), and when receiving a camera restriction release request (step S103), the system module 140 sets a normal mode (step S104). If neither request is received, the system module 140 maintains a set mode. The normal mode is a mode in which distribution of a camera image is not restricted. The normal mode may be set by default.

Next, referring to FIG. 9, when the camera restriction mode is set (step S201 = YES), the system module 140 stops acquisition of camera image data (step S202) and sets camera mute to be unchangeable (step S203).

On the other hand, when the normal mode is set (step S201 = NO), if a camera distribution button operation is performed (step S204 = YES), distribution of a camera image is started or stopped (step S205). If the camera image has already been distributed, the distribution is muted, and if the distribution of the camera image has been muted, the distribution is started. If there is no camera distribution button operation (step S204 = NO), a distribution or mute state up to then is maintained (step S206).

This processing example is an example of a case where the game execution unit 130 requests the system module 140 to stop distribution of the camera image. As described above, a method for restricting distribution of a camera image is not limited, and an appropriate processing example according to the method can be adopted.

### G. Modification

Restriction of distribution of a camera image may be executed when the display mode is a mode in which a background other than a person is displayed. As an example, distribution of a camera image is restricted when the display mode is the full-view mode, and distribution of the camera image may not be restricted when the display mode is the clipping mode or the face mode. This is because when the display mode is the clipping mode or the face mode, a video displayed on the display is masked and may not be included in the camera image. As an example, while distribution of a camera image is performed in the full-view mode, if a game application being executed enters a specific scene, the distribution of the camera image is stopped, and when a user changes the display mode to the clipping mode or the face mode, the distribution of the camera image may be restarted. At this time, a user interface for the user to switch the display mode may be set such that the full-view mode cannot be selected and at least one of the clipping mode or the face mode can be selected. Also, guidance by an image or sound that guides that distribution of a camera image is restricted in a current display mode may be executed at least for a user for whom distribution of a camera image is stopped.

When a game application that restricts distribution of a camera image is ended, or when a scene that restricts distribution of a camera image in a game application being executed is ended, distribution of the camera image may be automatically restarted immediately, or may not be restarted. For example, after end of restriction of distribution of a camera image, the distribution of the camera image may be automatically restarted after waiting for lapse of a specified time such as 5 seconds or 10 seconds. Also, for example, after end of restriction of distribution of a camera image, the distribution of the camera image is restarted based on a user operation, and may not be restarted automatically. For example, a user interface for selecting "OK" and or "NO" may be displayed together with a message such as "Restart distribution of camera image?", and the distribution of the camera image may be restarted based on the user operation. Also, for example, when restriction of distribution of a camera image ends, a message such as "Distribution of camera image is possible." may be displayed. The user may open a setting menu to release mute of the camera image based on the message. Also, for example, when restriction of distribution of a camera image ends, a setting menu for releasing mute of the camera image may automatically open. Such post-end processing after end of restriction of distribution of a camera image may be executed by the system module 140 based on a request from the game execution unit 130. The system module 140 may end the restriction of distribution of the camera image based on a request for ending the restriction of distribution of the camera image and execute the post-end processing, or may execute the post-end processing based on a request for executing the post-end processing separate from the request for ending the restriction of distribution of the camera image.

Restriction of distribution of a game image and restriction of distribution of a camera image may be synchronized. For example, when distribution of a camera image is restricted, distribution of a game image may also be restricted together. When the game execution unit 130 requests the system module 140 to restrict distribution of a camera image, the system module 140 may restrict not only distribution of the camera image but also distribution of a game image. Similarly, when distribution of a game image is also restricted, distribution of a camera image may also be restricted together. Also, restriction of distribution of a camera image and restriction of distribution of a game image may be executed independently. For example, distribution of a game image may not be restricted, but distribution of a camera image may be restricted.

As an example, in a case where the game execution unit 130 requests the system module 140 to restrict distribution of a camera image, the game execution unit 130 may always request restriction from the system module 140, or may request only when starting restriction. In the latter case, for example, the system module 140 may store the request for restriction even when the chat application 114 is not executed, and restrict distribution of the camera image based on the request for restriction when the chat application 114 is executed thereafter.

An icon image indicating an account corresponding to a game device may be displayed regardless of presence or absence of display of a camera image. When distribution of a camera image is muted, for example, by operation of a camera distribution button by a user, an announcement image indicating that the distribution is muted may be displayed. As an example, a mark indicating a camera and a mark indicating restriction may be displayed, or a message such as "Camera is muted." may be displayed. On the other hand, when a camera image cannot be displayed due to a game application being executed, an announcement image indicating that the camera image is muted based on, for example, operation of a camera distribution button by the user may not be displayed. On the other hand, for example, by displaying a message such as "This is a scene where a camera cannot be used." as described above, the user can easily understand a reason why the camera image is not displayed.

The system module 140 or the chat application 114 may not be able to distribute a game image.

In the present disclosure, for example, "a game application is being executed" may include a case where a game application is being executed in a foreground, and may or may not include a case where a game application is being executed in a background. For example, when a game application that restricts distribution of a camera image in a specific scene is executed in a foreground and a screen of the game application is displayed on a display, for example, when the screen is displayed as a game image 190, distribution of a camera image is restricted. When an application different from the game application is executed in a foreground and displayed on the display, distribution of the camera image may not be restricted.

An application that restricts distribution of a camera image is not limited to a game application, and may be another application. The application includes, for example, a home menu application, a main body setting menu application, a shop application, a screenshot browsing application, and a video content viewing application for movies, dramas, etc.

Each processing may be provided by cloud computing. For example, according to an operation on a terminal by a user, a game image of a game application may be generated by a server, and the generated game image may be transmitted to the terminal operated by the user. In this case also, it can be said that the game application is executed by the terminal. The same applies to execution of a chat application.

The embodiment disclosed this time should be considered as illustrative and not restrictive in all respects. The scope of the present invention is shown not by the above description but by the claims, and is intended to include all changes within the meaning and scope equivalent to the claims.

What is claimed is:

1. A system comprising:
one or more processors; and
one or more non-transitory computer-readable storage media having stored therein instructions that cause the one or more processors to perform operations comprising:
acquiring a captured image of a camera;
executing a chat application configured to distribute the captured image of the camera;
restricting distribution of the captured image of the camera by the chat application based on a first application being a game application or a video content viewing application executed simultaneously with the chat application.

2. The system according to claim 1, wherein
the chat application is configured to
distribute an image of an application executed simultaneously with the chat application; wherein,
the operations comprise restricting the distribution of the image of the first application by the chat application based on the first application executed simultaneously with the chat application.

3. The system according to claim 1, wherein
when the restriction of the distribution of the captured image of the camera based on the first application is released, the distribution of the captured image of the camera by the chat application is started based on a user operation.

4. The system according to claim 1, wherein
when the image of the first application being executed is displayed on a display, the distribution of the captured image of the camera by the chat application is restricted.

5. The system according to claim 1, wherein
when the distribution of the captured image of the camera by the chat application is restricted based on the first application being executed, a user of a terminal on which the chat application and the first application are executed is notified that the distribution of the captured image of the camera by the chat application is restricted.

6. The system according to claim 1, wherein
when the distribution of the captured image of the camera by the chat application in a terminal on which the chat application and the first application are executed is restricted, a user of another terminal chatting by the chat application with the terminal is notified that the distribution of the captured image of the camera by the chat application in the terminal is restricted.

7. The system according to claim 1, wherein
the captured image of the camera distributed by the chat application is an image based on a camera image display mode selected from a plurality of camera image display modes including a camera image display mode including a background of a person and a camera image display mode not including the background of the person;
when the selected camera image display mode is the camera image display mode including the background of the person, the distribution of the captured image of the camera by the chat application is restricted based on the first application.

8. The system according to claim 1, wherein
a terminal provided with the display on which the chat application and the first application are executed does not include a camera, and the camera is connected to the terminal.

9. The system according to claim 1, wherein
the chat application restricts the distribution of the captured image of the camera based on a request from the first application.

10. The system according to claim 9, wherein
the chat application is configured to:
acquire the captured image of the camera; and
distribute the acquired captured image: wherein,
the operations comprise restricting acquisition of the captured image of the camera by the chat application based on the request of the first application.

11. The system according to claim 1, wherein
the system includes a server, and
the server is configured to:
receive the captured image of the camera from a terminal on which the chat application is executed;
distribute the received captured image of the camera to another terminal on which the chat application is executed;
acquire information indicating that the first application is being executed in the terminal; and
restrict the distribution of the received captured image of the camera to the other terminal based on the information.

12. A computer-implemented method, comprising:
acquiring a captured image of a camera;
executing a chat application configured to distribute the captured image of the camera; and
restricting distribution of the captured image of the camera by the chat application based on a first application being a game application or a video content viewing application executed simultaneously with the chat application.

13. The computer-implemented method according to claim 12, wherein
the chat application is configured to
distribute an image of an application executed simultaneously with the chat application; wherein,
the computer-implemented method comprises restricting the distribution of the image of the first application by the chat application based on the first application executed simultaneously with the chat application.

14. The computer-implemented method according to claim 12, wherein
when the image of the first application being executed is displayed on a display, the distribution of the captured image of the camera by the chat application is restricted.

15. The computer-implemented method according to claim 12, wherein
the captured image of the camera distributed by the chat application is an image based on a camera image display mode selected from a plurality of camera image display modes including a camera image display mode including a background of a person and a camera image display mode not including the background of the person; when the selected camera image display mode is the camera image display mode including the background of the person, the distribution of the captured image of the camera by the chat application is restricted based on the first application.

16. The computer-implemented method according to claim 12, wherein
the chat application is configured to:
acquire the captured image of the camera; and
distribute the acquired captured image: wherein,
the computer-implemented method comprises restricting acquisition of the captured image of the camera by the chat application based on the request of the first application.

17. One or more non-transitory computer-readable storage media having stored therein instructions that cause one or more processors to perform chat operations comprising:
acquiring a captured image of a camera; executing a chat with another terminal;
distributing the captured image of the camera to the another terminal during the chat; and
restricting distribution of the captured image of the camera based on a first application being a game application or a video content viewing application, the first application being executed on a terminal.

18. The one or more non-transitory computer-readable storage media according to claim 17, wherein
when the image of the first application being executed is displayed on a display, the distribution of the captured image of the camera by the chat application is restricted.

19. The one or more non-transitory computer-readable storage media according to claim 17, wherein
the captured image of the camera distributed by the chat application is an image based on a camera image display mode selected from a plurality of camera image display modes including a camera image display mode including a background of a person and a camera image display mode not including the background of the person;
when the selected camera image display mode is the camera image display mode including the background of the person, the distribution of the captured image of the camera by the chat application is restricted based on the first application.

20. The one or more non-transitory computer-readable storage media according to claim 17, wherein
the chat application is configured to:
acquire the captured image of the camera; and
distribute the acquired captured image: wherein,
the chat operations comprise restricting acquisition of the captured image of the camera by the chat application based on the request of the first application.
